(19) United States
(12) Patent Application Publication
(10) Pub. No.: US 2022/0226935 A1
(43) Pub. Date: Jul. 21, 2022

(54) LASER MACHINING SYSTEM, MACHINING CONDITION SEARCH DEVICE, AND MACHINING CONDITION SEARCH METHOD

(71) Applicant: Mitsubishi Electric Corporation, Tokyo (JP)

(72) Inventors: Motoaki NISHIWAKI, Tokyo (JP); Kenta FUJII, Tokyo (JP); Kyohei ISHIKAWA, Tokyo (JP); Masaki SEGUCHI, Tokyo (JP); Hideyuki MASUI, Tokyo (JP)

(73) Assignee: Mitsubishi Electric Corporation, Tokyo (JP)

(21) Appl. No.: 17/611,582

(22) PCT Filed: Jun. 28, 2019
(86) PCT No.: PCT/JP2019/025958

§ 371 Date: Nov. 16, 2021

(51) Int. Cl. B23K 26/70

(52) U.S. Cl. CPC B23K 26/70

(57) ABSTRACT

A laser machining system according to the present invention includes a laser machining tool, a detection unit that detects a machining state of the laser machining tool, a test machining condition generation unit that generates a machining condition including at least one control parameter settable to the laser machining tool, a machining determination unit that determines quality of machining based on the machining state detected by the detection unit, a candidate condition generation unit that generates a candidate condition, which is a candidate for a machining condition to be set to the laser machining tool, based on a determination result from the machining determination unit and on a machining condition corresponding to the determination result, and a tolerance check unit that causes check machining to be performed for checking a machining tolerance using the candidate condition, where the machining tolerance indicates robustness of the candidate condition.

### FIELD

The present invention relates to a laser machining system, a machining condition search device, and a machining condition search method, each for searching a machining condition.

### BACKGROUND

Before performing machining that uses a laser machining tool, parameter values of control parameters for controlling the laser machining tool are set to the laser machining tool as a machining condition. To achieve desired quality of machining in laser machining, a suitable machining condition needs to be set. In general, this is conventionally performed such that the manufacturer of the laser machining tool obtains, through an experiment, a machining condition suitable for the plate thickness, the material, and/or the like of a workpiece in the development phase of the laser machining tool, and provides the user with the obtained machining condition, and the user then sets the machining condition provided from the manufacturer to the laser machining tool to perform machining.

However, machining using the machining condition provided as described above may suffer from variation in quality of machining due to the variety of the manufacturer, the production lot, the surface condition of the workpiece, variation in products of the laser machining tool, and/or the like, even when the plate thickness, the material, and/or the like of the workpiece is the same. When a variation exists in quality of machining, the machining condition is adjusted to achieve desired quality of machining. However, it is difficult for an unskilled operator to identify the cause of the variation, thereby taking time until a suitable machining condition is set. Taking a long time to adjust the machining condition will result in a long interruption of production that uses the laser machining tool.

Accordingly, technologies have been proposed for searching an optimum machining condition using a machine learning device. For example, Patent Literature 1 discloses a machine learning device that performs machine learning to associate state quantities of a laser machining system, including the surface condition and the temperature rise of the workpiece and the temperature of a component such as the laser oscillator, as well as laser machining condition data, with the machining result output from the machining result observation unit thus to obtain an optimum machining condition.

### CITATION LIST

### Patent Literature

Patent Literature 1: Japanese Patent Application Laid-open No. 2017-164801

### SUMMARY

### Technical Problem

However, the technology of Patent Literature 1 obtains an optimum machining condition through machine learning using state quantities, a machining result, and a machining condition of the past. Accordingly, when a factor that has not been taken into account as a state quantity causes a variation in the machining result, a desired machining result may not be obtained even with the use of the optimum machining condition that has been obtained using the technology described in Patent Literature 1. Machining using a configured machining condition is nevertheless desired to allow a desired machining result to be still obtained even when a factor that has not been taken into account as a state quantity causes a change in the actual optimum machining condition. That is, it is desirable that the laser machining tool be set with a robust machining condition that will provide a desired machining result even when the actual optimum machining condition somewhat changes. Thus, a technology is desired that enables checking whether the machining condition has robustness.

The present invention has been made in view of the foregoing, and it is an object of the present invention to provide a laser machining system capable of checking whether the machining condition has robustness.

### Solution to Problem

To solve the problem and achieve the object described above, a laser machining system according to the present invention includes a laser machining tool, a detection unit that detects a machining state of the laser machining tool, and a machining condition generation unit that generates a machining condition including at least one control parameter settable to the laser machining tool. The laser machining system also includes a machining determination unit that determines quality of machining based on the machining state detected by the detection unit, and a candidate condition generation unit that generates a candidate condition, which is a candidate for a machining condition to be set to the laser machining tool, based on a determination result from the machining determination unit and on a machining condition corresponding to the determination result. The laser machining system further includes a tolerance check unit that causes check machining to be performed for checking a machining tolerance using the candidate condition, where the machining tolerance indicates robustness of the candidate condition.

### Advantageous Effects of Invention

A laser machining system according to the present invention provides an advantage in being capable of checking whether the machining condition has robustness.

### BRIEF DESCRIPTION OF DRAWINGS

FIG. 1 is a diagram illustrating an example configuration of a laser machining system according to a first embodiment.

FIG. 2 is a diagram illustrating an example configuration of the processing circuitry of the first embodiment.

FIG. 3 is a flowchart illustrating an example of procedure of the machining condition search process in the laser machining system of the first embodiment.

FIG. 4 is a diagram illustrating an example of machine learning model used when a decision process is performed using machine learning by the machining determination unit of the first embodiment.

FIG. 5 is a diagram illustrating an example of decision process when the decision process is performed using signal processing by the machining determination unit of the first embodiment.

FIG. 6 is a diagram illustrating an example of good machining space of the first embodiment.

FIG. 7 is a diagram illustrating another example of good machining space of the first embodiment.

FIG. 8 is a diagram for describing test machining and check machining of the first embodiment.

FIG. 9 is a diagram illustrating an example of display screen displayed during test machining, by the display unit of the first embodiment.

FIG. 10 is a diagram illustrating an example of display screen displayed during check machining, by the display unit of the first embodiment.

FIG. 11 is a view illustrating an example of cut surface of a workpiece that has been cut by the laser machining tool of the first embodiment in a case of occurrence of rough surface irregularities.

FIG. 12 is a view illustrating an example of cut surface of a workpiece that has been cut by the laser machining tool of the first embodiment in a case of occurrence of flaws.

FIG. 13 is a view illustrating an example of cut surface of a workpiece that has been cut by the laser machining tool of the first embodiment in a case of occurrence of oxide film peel-off.

FIG. 14 is a view illustrating an example of cut surface of a workpiece that has been cut by the laser machining tool of the first embodiment in a case of dross generation.

FIG. 15 is a diagram illustrating an example configuration of a laser machining system according to a second embodiment.

### DESCRIPTION OF EMBODIMENTS

A laser machining system, a machining condition search device, and a machining condition search method according to embodiments of the present invention will be described in detail below with reference to the drawings. Note that these embodiments are not intended to limit the scope of this invention.

### First Embodiment

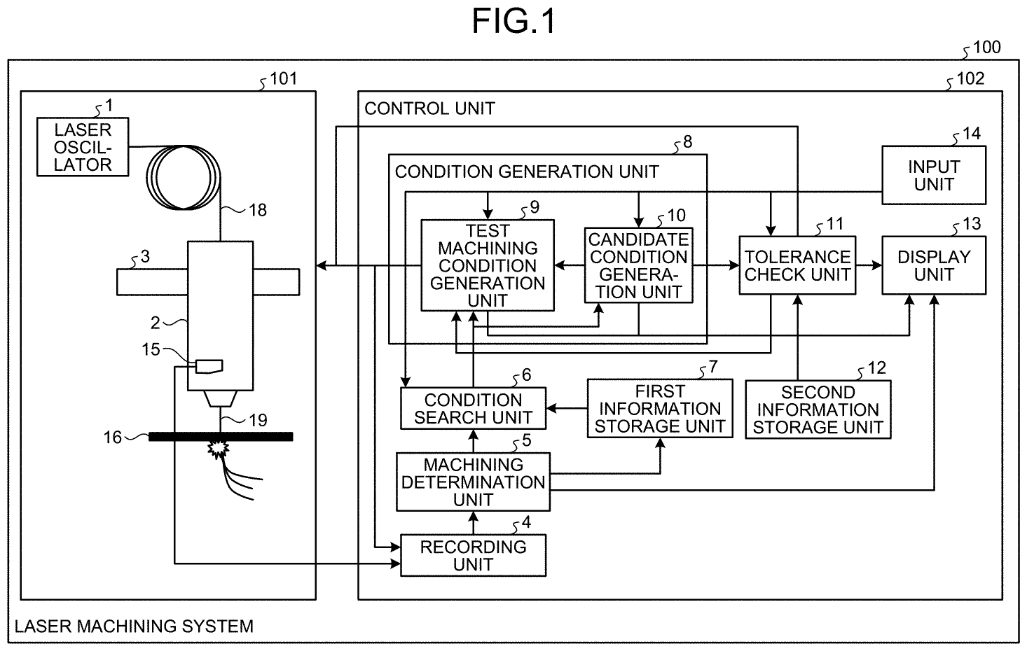

FIG. 1 is a diagram illustrating an example configuration of a laser machining system according to a first embodiment of the present invention. As illustrated in FIG. 1, a laser machining system 100 of the present embodiment includes a laser machining tool 101 and a control unit 102, which controls the laser machining tool 101.

The laser machining tool 101 includes a laser oscillator 1, a machining head 2, a drive unit 3, and a detection unit 15. Note that the detection unit 15 may be a component that is not a component of the laser machining tool 101. That is, the detection unit 15 may be provided separately from the laser machining tool 101. The laser oscillator 1 oscillates and emits a laser beam. The laser oscillator 1 is capable of, for example, switching between continuous oscillation and pulsed oscillation. When pulsed oscillation is used, the pulse frequency can be set. The laser oscillator 1 is not limited to those of such types, but may be one that generates only one of continuous oscillation and pulsed oscillation. The laser beam emitted from the laser oscillator 1 is supplied to the machining head 2 through an optical path 18. The machining head 2 is supplied with assist gas, and the assist gas is then supplied onto a workpiece 16 when the laser beam is emitted onto the workpiece 16. The machining head 2 includes a condenser lens (not illustrated) for focusing the laser beam onto the workpiece 16. The machining head 2 focuses and emits the laser beam 19 onto the workpiece 16 to cut the workpiece 16. The machining head 2 may also include therein a zoom lens. The machining head 2 also has a nozzle (not illustrated). The nozzle has an opening portion on the optical path between the condenser lens and the workpiece 16. This opening portion is passed through by the laser beam and by the assist gas. The drive unit 3 can change the position of the machining head 2 relative to the workpiece 16. For example, rotation of a motor included in the drive unit 3 under control of the control unit 102 causes a change in the position of the machining head 2 relative to the workpiece 16.

The detection unit 15 detects the machining state of the laser machining tool 101. Although FIG. 1 illustrates one detection unit 15, the required number of detection units 15 is one or more, and there may therefore be multiple detection units 15. Upon reception of a start machining signal described later, the detection unit 15 automatically detects the machining state of the workpiece 16. The detection unit 15 quantifies, as a state variable representing the machining state, at least one of, for example, the amplitude or the intensity of scattered light generated during machining, the spectrum of assist gas sound, oscillation of the machining pallet, acceleration of the drive shaft, the current value of the motor of the drive unit 3, and an image of the cut surface. The detection unit 15 outputs the quantified detection result to the control unit 102 as a machining signal. The detection unit 15 may be disposed inside or near the machining head 2, or may be disposed on the drive unit 3.

Note that the laser oscillator 1 may be of any type. The laser oscillator 1 may be a gas laser such as a carbon dioxide gas laser; a solid-state laser using a YAG crystal or the like as the gain medium; a fiber laser using an optical fiber as the gain medium; a direct diode laser that directly uses laser diode light; or the like.

Although the following description is directed to an example of cutting machining performed by the laser machining tool 101, the machining condition search method of the present embodiment is also applicable to other types of machining such as drilling by making a modification to the method of evaluating the machining result or the like to suit the particular machining type.

The control unit 102 controls the laser machining tool 101, and also functions as a machining condition search device of the present embodiment. For machining during operation such as production, the control unit 102 of the present embodiment has functionality to control the laser machining tool 101, and is also capable of performing a machining condition search process to search for a suitable machining condition. The control unit 102 performs a machining condition search process by performing machining, as test machining, using multiple machining conditions, and then searching for a machining condition that can achieve desired quality of machining using the result of the test machining. Test machining is machining for obtaining a candidate condition described later. Then, when the candidate condition of the test machining is met, the control unit 102 causes check machining to be performed for checking whether the machining condition that has been found in the test machining has robustness, and determines the machining condition that has been verified by the check machining to have robustness, to be the optimum machining condition.

As illustrated in FIG. 1, the control unit 102 of the present embodiment includes a recording unit 4, a machining determination unit 5, a condition search unit 6, a first information storage unit 7, a condition generation unit 8, a tolerance check unit 11, a second information storage unit 12, a display unit 13, and an input unit 14.

The recording unit 4 receives the machining signal output from the detection unit 15, associates the machining signal with a machining condition input from the condition generation unit 8, records therein the resulting information as test machining data, and outputs the test machining data to the machining determination unit 5. The machining condition includes one or more control parameters for controlling the laser machining tool 101. The machining condition is generally a set of parameter values of multiple respective control parameters. Examples of the control parameters include the laser output power, the assist gas pressure, the machining speed, the focus position, the focal spot diameter, the pulse frequency of the laser, the duty cycle of the pulse, the magnification of the zoom lens system in the machining head 2, the curvature change of adaptive optics (AO), the type of the nozzle, the diameter of the nozzle, the distance between the worked article to be cut and the nozzle, the distance of laser beam mode, and the amount of displacement between the nozzle hole center and the laser beam position. The control parameters may be one or more of these, and may include a parameter other than these. Any parameter settable for laser machining can be used without particular limitation.

The machining determination unit 5 determines quality of machining based on the machining state detected by the detection unit 15. In more detail, the machining determination unit 5 performs machine learning, signal processing, or the like based on the machining signal recorded in the recording unit 4 to calculate, as the determination result, an evaluation value that indicates whether the machining result is good or not. The machining determination unit 5 provides the determination result and the corresponding machining condition to the condition search unit 6, and stores the determination result and the corresponding machining condition in the first information storage unit 7. The condition search unit 6 estimates a determined-to-be-good region, which is a region in which quality of machining is expected to result in good quality, in a control parameter space, based on the determination result from the machining determination unit 5 and on the machining condition corresponding to the determination result. In more detail, the condition search unit 6 estimates a good machining region, which is a region in which desired quality is achieved, in a machining condition space, using the determination result from the machining determination unit 5 and information stored in the first information storage unit 7. That is, the condition search unit 6 searches for a machining condition for achieving desired quality. In the present embodiment, the term machining condition space refers to a space having a dimension or dimensions of one or more control parameters specified by the machining condition. Note that the term space as used herein refers to mathematical space, and thus includes one-dimensional space having only one control parameter being under consideration, and the like. Note that test machining is generally performed using multiple machining conditions. Accordingly, the machining determination unit 5 determines quality of machining for each of the multiple machining conditions, and the condition search unit 6 estimates the determined-to-be-good region based on the multiple machining conditions.

The first information storage unit 7 stores information for assisting the search operation performed in the condition search unit 6. First information is information that has been obtained in search operation previously performed in search for a machining condition. The first information includes, for example, information obtained by the manufacturer of the laser machining tool 101 or the like in the development phase. The manufacturer of the laser machining tool 101 has generally searched for an optimum machining condition through an experiment or the like in the development phase, and provides the optimum machining condition obtained through the search operation to the user. In the present embodiment, the information obtained by the search operation in the development phase is used as the first information, which enables the condition search unit 6 to efficiently perform a condition search. Examples of the information obtained by the search operation in the development phase include the ranges of the control parameters that have been set in the search operation in the development phase, the optimum machining condition obtained in the search operation in the development phase, and the result of estimation of the good machining region obtained in the search operation in the development phase. The first information also includes the determination result of a determination made in the past by the machining determination unit 5.

The condition generation unit 8 includes a test machining condition generation unit 9 and a candidate condition generation unit 10. The test machining condition generation unit 9, which is a machining condition generation unit, generates a machining condition for test machining, and outputs, to the laser machining tool 101, a control signal for controlling the laser machining tool 101 based on the machining condition generated. In the test machining, the test machining condition generation unit 9 may generate a machining condition by obtaining, via the condition search unit 6, machining conditions used in machining in the past and stored in the first information storage unit 7, and selecting one from the machining conditions used in machining in the past. This control signal includes a control command that controls the motor of the drive unit 3, a control command for controlling the laser oscillator 1, a control command for controlling the detection unit 15, and the like. At the start of each machining, the test machining condition generation unit 9 outputs a start machining signal to the laser machining tool 101 as a control signal. The test machining condition generation unit 9 also outputs the machining condition generated, to the recording unit 4. The candidate condition generation unit 10 determines whether a condition for terminating the test machining is met, and if the condition for terminating the test machining is met, determines to terminate the test machining, generates a candidate condition which is a candidate for an optimum machining condition to be set to the laser machining tool 101, and outputs the candidate condition to the tolerance check unit 11. The candidate condition generation unit 10 searches for, for example, the boundary between a good machining region and a poor machining region based on the good machining region estimated by the condition search unit 6, and generates a candidate condition based on the conditions used in the search and on the evaluation value obtained. Note that although the following description is directed to an example in which the candidate condition generation unit 10 obtains a candidate condition using the good machining region estimated by the condition search unit 6, any method may be used for generating a candidate condition as long as the method is based on the determination result from the machining determination unit 5 and on the machining condition corresponding to the determination result. For example, a candidate condition may be used whose determination result indicates good machining quality, among multiple determination results obtained by test machining. In a case in which the determination result is shown as an evaluation value, the candidate condition may be the machining condition that has resulted in the highest evaluation value among multiple evaluation values obtained by test machining.

The tolerance check unit 11 causes check machining to be performed using the candidate condition for checking the machining tolerance, which indicates robustness of the candidate condition. In more detail, the tolerance check unit 11 causes check machining to be performed to check whether the candidate condition has robustness, based on the candidate condition input from the candidate condition generation unit 10. If the candidate condition has robustness, the tolerance check unit 11 determines that the candidate condition is the optimum machining condition. The tolerance check unit 11 may use information stored in the second information storage unit 12 to check the machining tolerance of the candidate condition. The second information storage unit 12 stores information for assisting operation of the tolerance check unit 11. The display unit 13 performs display operation such as displaying a screen for receiving an input from the user, and displaying information generated in the control unit 102. The input unit 14 receives information input from the user, and outputs the information received, to the applicable unit(s).

In addition, during normal machining for production, the control unit 102 controls the laser oscillator 1 and the motor of the drive unit 3 to cause the laser beam to follow the machining path on the workpiece 16 by a component (not illustrated) according to, for example, a machining program and the machining condition that has been set. In this operation, the use of the optimum machining condition, as the machining condition, determined by the tolerance check unit 11 described above can provide highly robust machining.

Note that the present embodiment is described in the context of an example in which the control unit 102 of the laser machining system 100 functions as the machining condition search device of the present embodiment. However, the machining condition search device may be installed separately from the laser machining system 100.

A hardware configuration of the control unit 102 of the present embodiment will next be described. The machining determination unit 5, the condition search unit 6, the condition generation unit 8, and the tolerance check unit 11 of the control unit 102 are implemented by processing circuitry. The processing circuitry may be a dedicated hardware element or a circuit including a processor. The recording unit 4, the first information storage unit 7, and the second information storage unit 12 are implemented in a memory. Specifically, the recording unit 4 is implemented by a reception circuit for receiving a signal from the outside world and a memory. The display unit 13 is implemented by a display, a monitor, or the like. The input unit 14 is implemented by a keyboard, a mouse, or the like. The display unit 13 and the input unit 14 may be integrated and implemented as a touch panel.

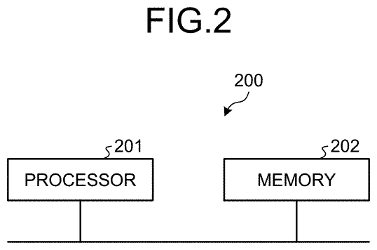

In a case in which the processing circuitry is circuitry including a processor, the processing circuitry is, for example, processing circuitry configured as illustrated in FIG. 2. FIG. 2 is a diagram illustrating an example configuration of the processing circuitry of the present embodiment. The processing circuitry 200 illustrated in FIG. 2 includes a processor 201 and a memory 202. In a case in which the machining determination unit 5, the condition search unit 6, the condition generation unit 8, and the tolerance check unit 11 are implemented by the processing circuitry 200 illustrated in FIG. 2, the processor 201 reads and executes a program stored in the memory 202 to implement these units. That is, in a case in which the machining determination unit 5, the condition search unit 6, the condition generation unit 8, and the tolerance check unit 11 are implemented by the processing circuitry 200 illustrated in FIG. 2, the functionality thereof is implemented by a program or programs, i.e., software. The memory 202 is also used as a work area of the processor 201. The processor 201 is a central processing unit (CPU) or the like. The memory 202 is, for example, a non-volatile or volatile semiconductor memory such as a random access memory (RAM), a read-only memory (ROM), or a flash memory; a magnetic disk, or the like.

In a case in which the machining determination unit 5, the condition search unit 6, the condition generation unit 8, and the tolerance check unit 11 are implemented by a dedicated hardware element, the processing circuitry is, for example, a field programmable gate array (FPGA) or an application specific integrated circuit (ASIC). Note that the machining determination unit 5, the condition search unit 6, the condition generation unit 8, and the tolerance check unit 11 may be implemented by a combination of processing circuitry including a processor, and a dedicated hardware element. The machining determination unit 5, the condition search unit 6, the condition generation unit 8, and the tolerance check unit 11 may also be implemented by multiple pieces of processing circuitry.

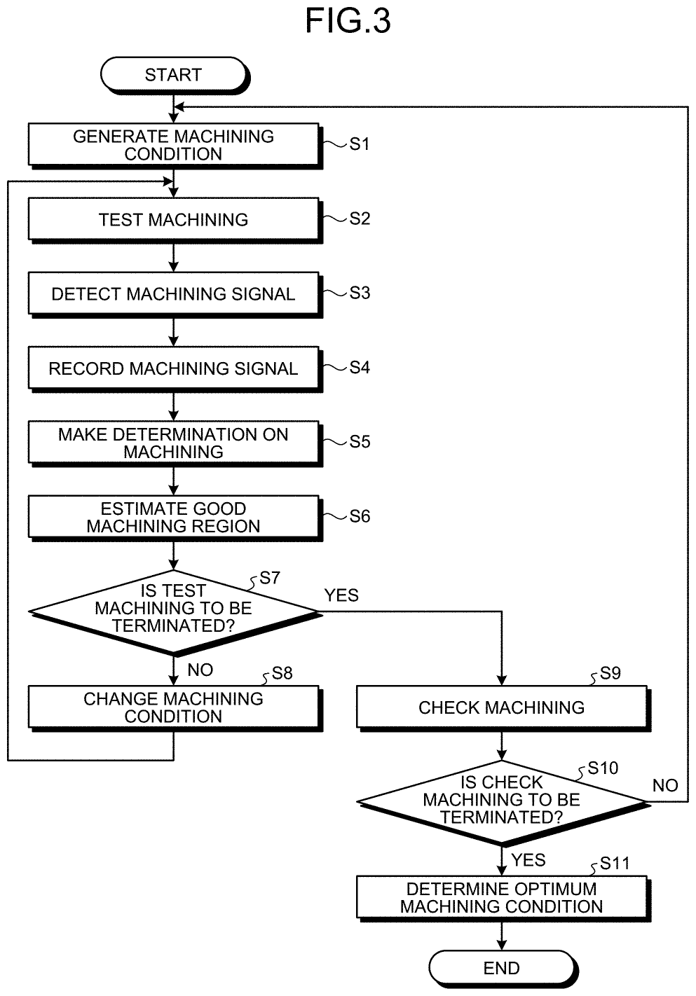

An operation of the present embodiment will next be described. FIG. 3 is a flowchart illustrating an example of procedure of the machining condition search process in the laser machining system 100 of the present embodiment. First, the laser machining system 100 generates a machining condition for test machining (step S1). In more detail, the test machining condition generation unit 9 of the control unit 102 generates a machining condition for test machining. The machining condition generated by the test machining condition generation unit 9 at step S1 is a machining condition at the start of test machining, and may be determined in any practical manner. For example, the initial machining condition may be generated by a random combination of the parameter values of the control parameters, may be generated based on information stored in the first information storage unit 7, or may be specified by the user. In addition, the laser machining system 100 may first perform test machining multiple times as an initial search, which is performed independently of the estimation result obtained by the condition search unit 6, and then perform an estimation search, which is test machining performed after generation of a machining condition using the estimation result obtained by the condition search unit 6. The number of times of performing these types of test machining may be predetermined or may be set by the user.

Next, the laser machining system 100 performs test machining (step S2). In more detail, the test machining condition generation unit 9 generates a control signal for controlling the laser machining tool 101 based on the machining condition, and outputs the control signal to the laser machining tool 101. The laser machining tool 101 machines the workpiece 16 based on the control signal output from the test machining condition generation unit 9.

Next, the laser machining system 100 detects a machining signal (step S3), and records the machining signal (step S4). In more detail, at step S3, the detection unit 15 detects the machining state, and outputs the detection result to the control unit 102 as the machining signal. At step S4, the recording unit 4 of the control unit 102 receives the machining signal, associates the machining signal with the machining condition, records therein the resulting information as test machining data, and outputs the test machining data to the machining determination unit 5.

Next, the laser machining system 100 makes a determination with respect to the machining (step S5). In more detail, the machining determination unit 5 extracts a characteristic quantity based on the machining signal contained in the machining data input from the recording unit 4, determines whether the machining quality is good or not using the characteristic quantity, associates the determination result with the machining condition, outputs the resulting information to the condition search unit 6, and stores the resulting information in the first information storage unit 7. The characteristic quantity may be a quantity extracted from a captured image of a cut surface, the peak frequency of the spectrum of assist gas sound, or the like. The characteristic quantity may be any information usable for whether the machining quality is good or not.

In addition, an evaluation value, which is a determination result as to whether the machining quality is good or not, may be a numerical value representing a rank, or may be a continuous value. The evaluation value is a value representing machining quality in other words. When the evaluation value represents a rank, the evaluation value may be two-rank data and have one of two values, which are good and poor, or may be a value representing one of three or more defect levels. The evaluation value may otherwise be a value of probability such as, for example, good quality with a probability of 70%. Alternatively, the evaluation value may be determined by normalization of a value between 0 and 1, where 0 is the lower limit and 1 is the upper limit of the evaluation value for the machining defect that has occurred, with a definition that 1 means the best. Further alternatively, in a case in which multiple types of machining defect, i.e., multiple machining defect modes, are expected, and the machining determination unit 5 is to determine which machining defect mode has occurred, the machining determination unit 5 may determine the evaluation value for each of the machining defect modes, and output the sum of the values of the respective machining defect modes as the evaluation value. The determination result from the machining determination unit 5 may otherwise be a machining defect mode. In this case, the machining determination unit 5 outputs, as the determination result, for example, information indicating one of defect mode #1, defect mode #2, . . . , defect mode #n, and no machining defect, i.e., good machining quality. Still alternatively, the machining determination unit 5 may determine whether the machining quality is defective for each machining defect mode, and determine that the machining quality is defective when the machining quality is defective for at least one machining defect mode.

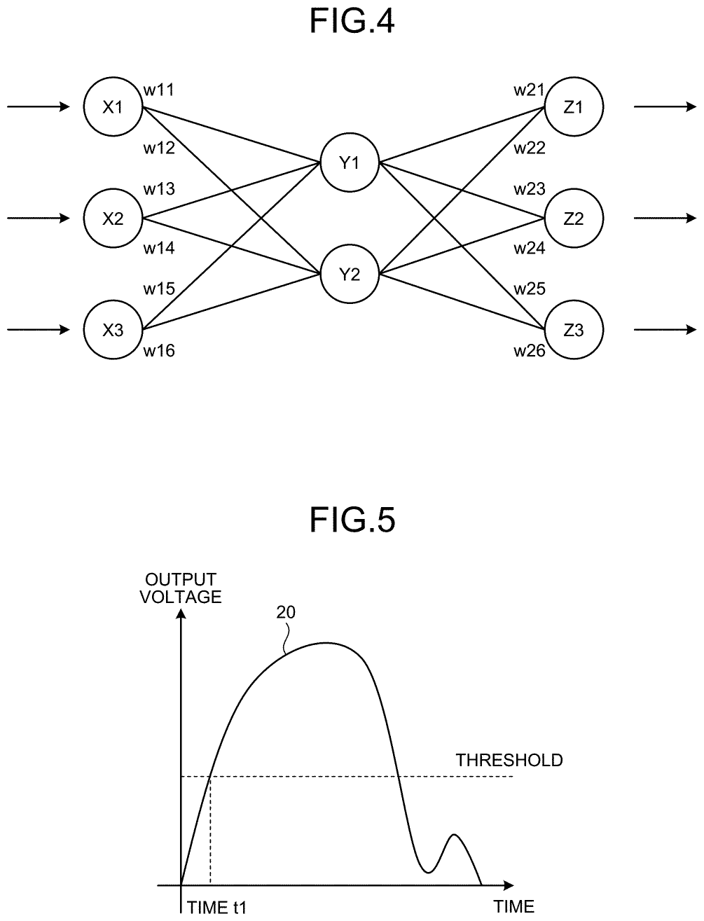

The decision process of the machining determination unit 5 may be performed using machine learning or using signal processing such as threshold determination. FIG. 4 is a diagram illustrating an example of machine learning model used when the decision process is performed using machine learning by the machining determination unit 5 of the present embodiment. The example illustrated in FIG. 4 applies neural network as machine learning. As illustrated in FIG. 4, this neural network has input layer nodes X1, X2, and X3, middle layer nodes Y1 and Y2, and output layer nodes Z1, Z2, and Z3. Each of the input layer nodes may be configured to receive a machining signal such as the current value of the motor, the amplitude or the intensity of scattered light generated during machining, or receive an extracted characteristic quantity. In the case in which a machining signal is to be input to each of the input layer nodes, the characteristic quantity will be extracted also using machine learning. In the case in which an extracted characteristic quantity is to be input to each of the input layer nodes, the machining determination unit 5 extracts the characteristic quantity from the machining signal, and then inputs the characteristic quantity to the input layer.

Each of the input layer nodes weights the input signal, and outputs the resulting signal to each of the middle layer nodes. Each of the middle layer nodes weights the input signal, and outputs the resulting signal to each of the output layer nodes. Each of the output layer nodes performs operation using an activation function or the like on the signal input from the middle layer, and outputs the resulting signal as the determination result. Note that although the illustrated example includes a single middle layer, two or more middle layers may be included. The weighting factor at each neuron is calculated using an error backpropagation method that uses a labeled training signal, or the like. That is, by using so-called supervised learning, information indicating whether the machining quality is good or not, or a machining defect mode, is output based on what has been pre-learned. Pre-learning is performed such that, for example, machining is performed, the operator evaluates the result of the machining, and provides a corresponding machining signal and the result of evaluation as the labeled training data.

The machining determination unit 5 may also use deep learning as the learning algorithm of machine learning to learn extraction of the characteristic quantity itself. Examples of typical technique therefor include neural network, convolutional neural network (CNN), and recurrent neural network (RNN). Alternatively, the learning algorithm of machine learning may also be another known algorithm, such as, for example, genetic programming, functional logic programming, Fisher discriminant analysis, a subspace approach, discriminant analysis using Mahalanobis space, or a support-vector machine.

FIG. 5 is a diagram illustrating an example of decision process when the decision process is performed using signal processing by the machining determination unit 5 of the present embodiment. In FIG. 5, the horizontal axis represents time, and the vertical axis represents the output voltage, which is a value obtained by conversion, into voltage, of a value of scattered light generated during machining. A machining signal 20 represents an output voltage detected by the detection unit 15 during a certain machining operation. For example, the machining determination unit 5 determines that the machining quality is defective when the output voltage is greater than a threshold. In the example illustrated in FIG. 5, the machining signal 20 has a value exceeding the threshold at time t1, and therefore the machining quality relating to this machining signal 20 is determined to be defective. The case of FIG. 5 is merely by way of example, and a threshold may be set for each of multiple ranks to calculate an evaluation value for each of the multiple ranks. Note that the criterion to determine whether machining quality is good or not depends on the user-operator. The user may be allowed to determine the threshold(s).

Returning to the description with reference to FIG. 3, after step S5, the laser machining system 100 estimates the good machining region (step S6). Specifically, the condition search unit 6 estimates the good machining region based on pairs of a machining condition and an evaluation value stored in the first information storage unit 7, and on pairs of a machining condition and an evaluation value input from the machining determination unit 5. The first information storage unit 7 stores not only pairs of a machining condition that has been used in the search and an evaluation value, but also information obtained in the development phase as described above. In addition, when the condition search unit 6 determines the good machining region in a space having dimensions of control parameters included in the machining condition, the control parameters that form the space for determining the good machining region may be predetermined or configurable by the user. In addition, the range and the increment value of search with respect to each control parameter during the search for the good machining region may also be predetermined or configurable by the user. For example, given a space formed of parameter A and parameter B, search is made in a range from a1 to a2 with an increment Aa for parameter A, and in a range from b1 to b2 with an increment Ab for parameter B.

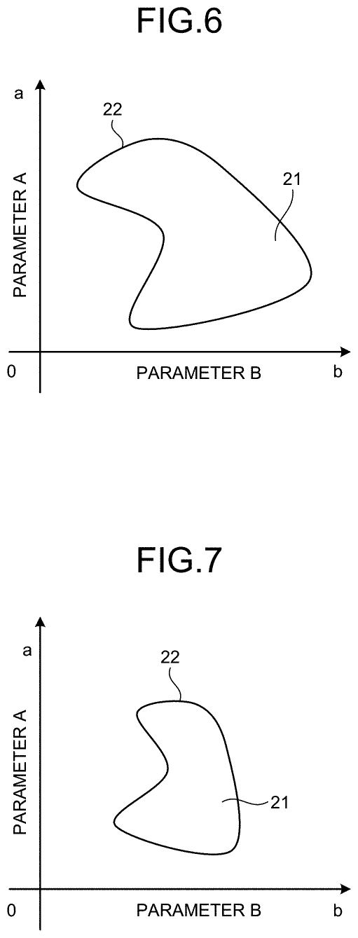

FIG. 6 is a diagram illustrating an example of good machining space of the present embodiment. In FIG. 6, the vertical axis represents parameter value a of parameter A, which is one of the control parameters, and the horizontal axis represents parameter value b of parameter B, which is also one of the control parameters. The region 21 represents the good machining region in a two-dimensional space formed of parameter A and parameter B, and the boundary 22 is the border line between the good machining region and the poor machining region. A good machining region is, for example, a region in which the evaluation value is greater than or equal to a threshold. The criterion to determine whether a region is the good machining region is configurable by the user. Although FIG. 6 illustrates the region 21, which is the actual good machining region, the condition search unit 6 estimates the region 21 based on the evaluation values at discrete points to search for the good machining region. These discrete points depend on the range and the increment value of search with respect to each control parameter described above. Because each evaluation value corresponds to a discrete point, and each evaluation value has an error, the good machining region estimated by the condition search unit 6 is completely not coincident with the region 21, in general.

FIG. 7 is a diagram illustrating another example of good machining space of the present embodiment. In the example illustrated in FIG. 7, the region 21 has changed from that in FIG. 6 due to a different rod of a workpiece 16 different from the one in the example illustrated in FIG. 6, which has also caused the boundary 22 to change from that in FIG. 6. Thus, even when the plate thickness, the material, and the like are the same, the good machining region may change for some reason. In the present embodiment, estimation of the good machining region using the result of test machining allows the good machining region to be estimated using the condition of machining used in actual production.

Note that when a control parameter has a range in which damage may be caused to a certain unit in the laser machining system 100 such as the machining head 2 or to the workpiece 16 during the search for the machining condition, a condition to inhibit that search may be set to avoid performing test machining in such range. For example, the first information storage unit 7 stores a range of a control parameter in which search should be inhibited, and the condition search unit 6 avoids this range in the search for the good machining region, and instructs the test machining condition generation unit 9 to generate a machining condition while avoiding this range. For example, a machining condition that is a machining speed as low as 60% of a standard condition may be excluded due to possibility of causing a machining defect such as dross. Note that the standard machining condition is the machining condition provided by the manufacturer.

In addition, when the test machining condition generation unit 9 displays a machining condition to be used in the next test machining on the display unit 13, and receives, from the user, an input indicating that the user does not wish machining using that machining condition, the test machining condition generation unit 9 may display another machining condition on the display unit 13 as a candidate for the next machining condition instead of determining that such machining condition that the user does not wish to use is the machining condition for the next test machining. The user checks the machining condition to be used in the next test machining that is being displayed, and upon a determination that a machining defect will occur, the user enters an input not to perform test machining using that machining condition.

The condition search unit 6 estimates the good machining region based on combinations of a machining condition and an evaluation value obtained by test machining and on information obtained in the development phase. Note that the good machining region may be estimated using the information obtained by test machining without using information obtained in the development phase. That is, the condition search unit 6 obtains an evaluation value as a function of the corresponding control parameter using an estimation algorithm using information stored in the first information storage unit 7, and determines the region in which that evaluation value is greater than or equal to a threshold to be the good machining region. The estimation algorithm for use in the search may be any method that estimates the estimation target based on observed data, and may be, for example, Gaussian process regression, or another known method such as Bayesian inference or maximum likelihood estimation. Note that when the machining determination unit 5 outputs a determination result that is a machining defect mode, the condition search unit 6 estimates an applicable region for each of the machining defect modes, and excludes the estimated region(s) thus to estimate the good machining region. The condition search unit 6 then outputs the calculated result to the candidate condition generation unit 10.

In addition, when the machining determination unit 5 outputs a determination result that is a machining defect mode, the condition search unit 6 may determine the control parameter to be used in the search, based on the machining defect mode, and instruct the test machining condition generation unit 9 to generate a machining condition including the determined control parameter whose value has been modified. An affected control parameter may be identifiable depending on the machining defect mode. In such a case, association between a machining defect mode and a control parameter, and performing test machining to preferentially modify the value of the control parameter associated with the machining defect mode allows the good machining region to be efficiently searched for when the determination result is defective. Moreover, the condition search unit 6 may correct the value of a control parameter based on the machining defect mode. The control parameter whose value is to be corrected and the amount of correction may be stored, in association with the machining defect mode, in a table or the like in the first information storage unit 7, or may be entered by the user. Furthermore, when the determination result output from the machining determination unit 5 is an evaluation value representing a defect level, a weight may be applied in modification of the amount of correction of the control parameter whose value is to be corrected, or the value of the control parameter to be corrected may be directly modified. In addition, when there is a rule managed by an expert, such a rule may be used. An expert may have, as expertise, a rule of how a control parameter should be corrected depending on the state of the laser machining tool 1. Storing the rule managed by an expert in the first information storage unit 7 as information for correcting the value of a control parameter, and making a correction based on this information by the condition search unit 6 enables the good machining region to be efficiently searched for, with the use of the expertise of an expert.

Returning to the description with reference to FIG. 3, after step S6, the laser machining system 100 determines whether to terminate the test machining (step S7). In more detail, the candidate condition generation unit 10 determines whether a condition for terminating the test machining is met. The condition for terminating the test machining may be, for example, a condition that the condition search unit 6 has completed estimation in a predetermined range, a condition that the machining determination unit 5 has output a determination result corresponding to good machining quality five or more times consecutively, a condition that test machining has been performed a predetermined number of times, or the like. In addition, the process may proceed to check machining in a case in which after the above condition is met, the user has been allowed to enter an input specifying whether to proceed to check machining, and an input has been entered from the user specifying proceeding to check machining. When an input has been entered from the user specifying not to proceed to check machining, the test machining is continued or the machining condition search process is terminated. An example of the condition that the condition search unit 6 has completed estimation in a predetermined range may be a condition that in a case in which the estimation algorithm used by the condition search unit 6 is an estimation algorithm capable of estimating an estimation error, the estimation error is less than or equal to a certain value. Alternatively, the candidate condition generation unit 10 may calculate the area or the volume of the good machining region determined by the condition search unit 6, and then determine to terminate the test machining when the calculated value is greater than a certain value. Still alternatively, the candidate condition generation unit 10 may terminate the test machining when the parameter value of a control parameter included in a machining condition selected as a candidate condition described later changes by an amount less than or equal to a certain value.

If the test machining is not to be terminated (No at step S7), the laser machining system 100 changes the machining condition (step S8), and repeats the process from step S2. In more detail, the candidate condition generation unit 10 instructs the test machining condition generation unit 9 to continue the test machining, and the test machining condition generation unit 9 generates a next machining condition for the test machining, and performs again the operation of step S2. The test machining condition generation unit 9 may, for example, generate a machining condition at random in a predetermined range or in a range specified by the user, or predetermine a set of lattice points within the search range, on each of which the test machining is to be performed, and sequentially generate a machining condition correspondingly to each of these points. In addition, to efficiently estimate the good machining region, the laser machining system 100 may selectively narrow machining conditions for use in the test machining, using a relationship between the value of the control parameter and the evaluation value, calculated by the condition search unit 6, instead of performing the test machining for each lattice point within the search range. For example, the test machining condition generation unit 9 may generate a machining condition at a point near the boundary between the good machining region and the poor machining region based on the relationship between the value of the control parameter and the evaluation value, or generate a machining condition based on a certain criterion such as a point at a certain distance from the boundary. Narrowing of candidate points is advantageous in reducing the number of times of search operations.

If the test machining is to be terminated (Yes at step S7), the laser machining system 100 performs check machining (step S9). In more detail, if the test machining is to be terminated (Yes at step S7), the candidate condition generation unit 10 selects a candidate condition using a search result from the condition search unit 6, and provides the candidate condition to the tolerance check unit 11. The candidate condition may be the condition estimated to provide the highest evaluation value in the good machining region estimated by the condition search unit 6, the condition corresponding to the center of gravity of the good machining region, or the like. Upon reception of the candidate condition, the tolerance check unit 11 generates a machining condition for check machining based on the candidate condition, generates a control command for controlling the laser machining tool 101, based on the generated machining condition, and outputs the control command to the laser machining tool 101. The tolerance check unit 11 modifies the value of at least one control parameter of the candidate condition before performing of the check machining, and then causes the check machining to be performed using the modified machining condition.

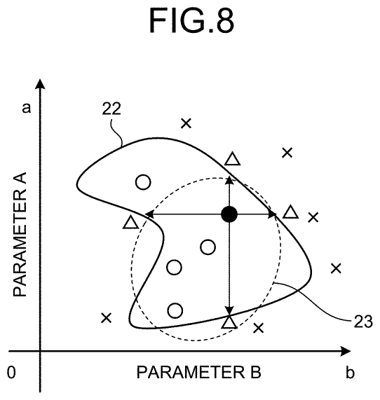

Check machining will now be described. FIG. 8 is a diagram for describing test machining and check machining of the present embodiment. In FIG. 8, the vertical axis represents parameter value a of parameter A, and the horizontal axis represents parameter value b of parameter B. The boundary 22 is the boundary between the actual good machining region and the poor machining region, similar to that in the example illustrated in FIG. 6. A boundary 23 represents the boundary between the good machining region estimated by the condition search unit 6 and the poor machining region. The circles in FIG. 8 each represent a point determined to represent good machining quality in a test machining region. The crosses in FIG. 8 each represent a point determined to represent poor machining in the test machining region. As illustrated in FIG. 8, the boundary 23, which is the estimated boundary, may differ from the boundary 22, which is the new boundary. Accordingly, in the operation of the present embodiment, after the good machining region is estimated to determine a candidate condition, the check machining is then performed to check whether the machining tolerance of the candidate condition can be greater than or equal to a predetermined criterion. As used herein, the term machining tolerance indicates the likelihood that desired quality of machining is achieved when machining is performed using a certain machining condition even when an unintended machining result has resulted due to some factor. That is, a machining tolerance indicates robustness. A machining tolerance can be expressed by, for example, the distance of a point representing a certain machining condition from the boundary between the good machining region and the poor machining region. FIG. 8 illustrates the candidate condition using a solid black circle, whose machining tolerance is illustrated by the arrows.

In the step of performing check machining, the tolerance check unit 11 generates a machining condition for use in the check machining based on information stored in the second information storage unit 12. The second information storage unit 12 stores, for example, information about the machining tolerance for each control parameter, used in the development phase. The information about the machining tolerance is information indicating the degree of machining tolerance that should be satisfied with respect to each control parameter.

Machining defects can be classified into two types, i.e., “one that occurs unexpectedly” and “one that does not occur unexpectedly”. Examples of machining defect that occurs unexpectedly include:
Stain on an optical system such as a protecting glass,
Damage or deformation of the nozzle, and
Poor tracing control due to adhesion of sputter onto the nozzle.

These results are difficult to detect before occurrence.

Examples of machining defect that does not occur unexpectedly include:
Axial misalignment (state in misalignment between the process nozzle center and the centers of the laser beam and of the assist gas),
Surface condition and composition change of the workpiece 16,
Heat-accumulated state of the workpiece 16,
Adjustment of the machining condition, and
Thermal lensing (change in an optical characteristic due to heat accumulated in an optical element).

In addition, even when a factor exists that is exemplified above as “machining defect that does not occur unexpectedly”, the following factors may cause a change in the good machining region without being known to the user.
Variation in centering operation for aligning the process nozzle center with the centers of the laser beam and of the assist gas
Output power stability of the laser oscillator

Factors such as those described above may prevent good machining due to a factor unknown to the user even when machining is performed using a machining condition that should provide good machining quality. To obtain good machining quality, i.e., desired quality, even upon occurrence of such change, the tolerance check unit 11 of the present embodiment modifies the value of at least one control parameter in the candidate condition, and checks whether good machining quality will still be obtained during check machining, to check the machining tolerance of the candidate condition. Thus, when, in check machining, the candidate condition is modified by an amount corresponding to a predetermined criterion to ensure the machining tolerance, and good machining quality is obtained as the result, that candidate condition can be determined to have a machining tolerance greater than or equal to the predetermined criterion (hereinafter referred to as reference value).

The method of modifying the candidate condition may be, for example, to increase and decrease a value specified in the candidate condition by 5% of that value, or to modify such a value by a predetermined constant value. For example, assuming that the control parameters of the candidate condition include focus position and the focus position is to be modified by a constant value of 0.5 [mm], the tolerance check unit 11 sets a machining condition having a focus position obtained by adding 0.5 [mm] to the focus position that has been set in the candidate condition, and a machining condition having a focus position obtained by subtracting 0.5 [mm] from the focus position that has been set in the candidate condition, each as the machining condition. Note that the above example assumes that a parameter value is increased and decreased by a same amount of change, but a parameter value may be increased and decreased by different values.

In addition, information about the amount of change for modifying the candidate condition may be stored in the second information storage unit 12, and the tolerance check unit 11 may then determine the amount of change based on the information stored in the second information storage unit 12. For example, a likely range of change in the good machining region due to the above factors is determined in advance for a control parameter whose value may change due to a factor such as those described above, based on the machining result obtained in the development phase; and this range of change is stored in the second information storage unit 12. Alternatively, the second information storage unit 12 may store information representing the foregoing amount of change obtained by expertise of a skilled operator.

Moreover, the second information storage unit 12 may store, in the form of a table, numerical values such as information of machining conditions obtained in the designing phase, adjustable ranges of machining parameters, stability of the laser oscillator 1, and the capacity of cooling the machining head 2. Specifically, information obtained in the designing phase or in adjustment work in the past, such as variation in the laser output power, permissible machining tolerance of assist gas pressure, permissible machining tolerance of machining speed, the amount of variation in the focus position, variation in the focal spot diameter, the temperature change in the zoom lens system, the type of the nozzle, the diameter of the nozzle, tolerance of variation in centering operation, variation in detection of the distance between the worked article being cut and the nozzle, are stored in advance in the second information storage unit 12. In addition, such items of information known to a skilled operator may be added to the table. Then, the tolerance check unit 11 may look up the table to obtain the reference value required of each control parameter included in the candidate condition. For example, the permissible machining tolerance of assist gas pressure is directly usable as the reference value of the machining tolerance with respect to the assist gas pressure, which is one of the control parameters. Control parameters whose information is not directly usable as the reference value are provided in advance with a conversion rule or the like, and the tolerance check unit 11 calculates the reference value for such a control parameter using the conversion rule.

Furthermore, the good machining region may change with the time of laser irradiation to an element of the laser machining tool 101, such as a thermal lens. Therefore, check machining may be performed after beam irradiation for a certain time period or longer to cause the laser irradiation time calculated using the information stored in the second information storage unit 12 to match the laser irradiation time in the check machining. For example, upon reception of a candidate condition from the candidate condition generation unit 10, the tolerance check unit 11 may perform check machining after laser beam irradiation of 10 minutes or longer.

Returning to the description with reference to FIG. 3, after step S9, the laser machining system 100 determines whether to terminate the check machining (step S10), and if the check machining is to be terminated (Yes at step S10), determines an optimum machining condition (step S11), and terminates the machining condition search process. The optimum machining condition is used in normal machining, which is the machining for production. In more detail, at step S10, the tolerance check unit 11 determines whether machining has been performed using all the machining conditions needing check machining, and the determination results from the machining determination unit 5 all indicate good machining quality in the check machining. Note that in a case in which the determination result from the machining determination unit 5 is an evaluation value, the tolerance check unit 11 determines that the machining is good machining when the evaluation value is greater than or equal to a desired value. The phrase “machining using all the machining conditions needing check machining” refers to machining performed using the machining conditions in which the values of all the control parameters requiring modification, of the control parameters of the candidate condition, have each been modified to increase and decrease. For example, in a case in which foregoing parameter A and parameter B are to be each modified to increase and decrease, machining will be performed using four machining conditions in total. Thus, machining using these four machining conditions will be the “machining using all the machining conditions needing check machining”. At step S11, the tolerance check unit 11 determines that the candidate condition is the optimum machining condition.

Note that the tolerance check unit 11 may correct the value of a parameter of the machining condition for use in the check machining, based on the determination result from the machining determination unit 5, and perform the check machining again using the candidate condition obtained by the correction. That is, when the candidate condition does not have a machining tolerance that meets a predetermined criterion, the tolerance check unit 11 may modify the value of at least one or some of the control parameters of the candidate condition, and cause the check machining to be performed again based on the candidate condition obtained by the modification. For example, when machining is performed using all the machining conditions needing check machining, and one or some of the determination results from the machining determination unit 5 indicate poor machining quality in the check machining, the tolerance check unit 11 determines, for example, whether the parameter value of the corresponding control parameter is correctable based on the good machining region obtained by the condition search unit 6. Assume here that the candidate condition has, for example, a machining tolerance in the decreasing direction of parameter A being greater than the reference value by amount X, and a machining tolerance in the increasing direction of parameter A being less than the reference value by amount Y, where the machining tolerance is the distance from the boundary between the good machining region and the poor machining region, and amount X is greater than amount Y. In this case, considering that the check machining after the modification to increase parameter A results in poor machining, the tolerance check unit 11 may correct the candidate condition to decrease parameter A by amount Y, and then perform check machining again based on the candidate condition obtained by the correction.

In addition, in a case in which the determination result from the machining determination unit 5 is an evaluation value, the tolerance check unit 11 may display, on the display unit 13, the margin of the evaluation value corresponding to the candidate condition relative to the threshold of the evaluation value for obtaining a determination of good machining quality, i.e., the difference between the evaluation value corresponding to the candidate condition and the threshold of the evaluation value for obtaining a determination of good machining quality.

If the check machining is determined not to be terminated at step S10 (No at step S10), the laser machining system 100 repeats again the process from step S1. In this operation, due to a possibility of the same result from test machining using the same machining condition, a machining condition that has not yet set in immediately previous or earlier test machining is selected as the initial value, and is thus generated at step S1.

As described above, when the candidate condition has a machining tolerance that meets a predetermined criterion, the tolerance check unit 11 determines that such a candidate condition is the optimum machining condition. Otherwise, if the candidate condition does not have a machining tolerance that meets a predetermined criterion, the tolerance check unit 11 instructs the test machining condition generation unit 9 to generate a machining condition. When the test machining condition generation unit 9 is instructed by the tolerance check unit 11 to generate a machining condition, the process of the test machining condition generation unit 9, of the machining determination unit 5, of the candidate condition generation unit 10, and of the tolerance check unit 11 is performed again.

FIG. 8 referred to above illustrates points where check machining is performed by triangles. The solid black circle represents the candidate condition. FIG. 8 illustrates a case in which the check machining is performed at four points to which the point of candidate condition indicated by the solid black circle has been moved up and down for each of parameter A and parameter B. When the check machining under these conditions results in good machining quality, this means that the candidate condition indicated by the solid black circle has a machining tolerance greater than or equal to a threshold, and is thus the optimum machining condition.

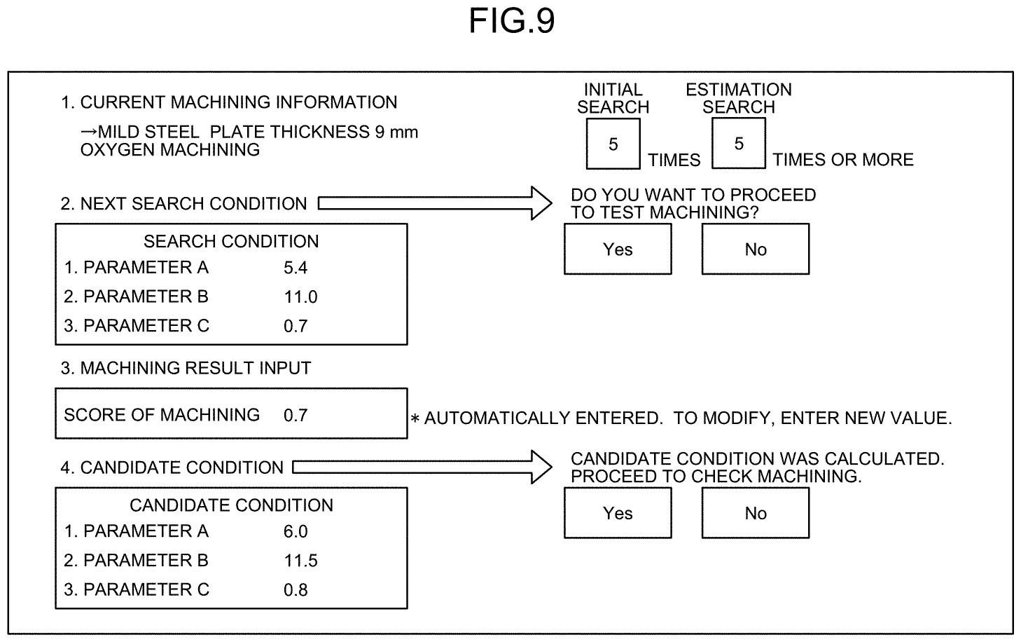

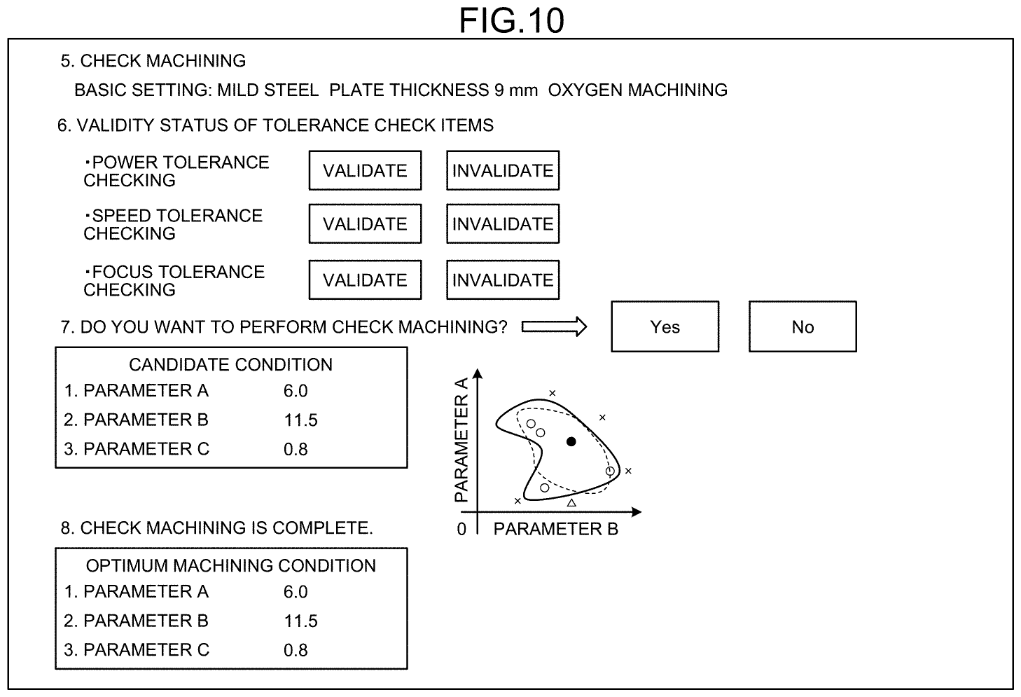

An example of display on the display unit 13 of the present embodiment will next be described. FIGS. 9 and 10 are each a diagram illustrating an example of display screen displayed by the display unit 13 of the present embodiment. FIG. 9 illustrates a screen displayed during test machining. FIG. 10 illustrates a screen displayed during check machining. These display screens also display input fields and buttons to receive inputs from the user. The user examines the screens illustrated in FIGS. 9 and 10, and handles the input fields and the buttons.

In the example illustrated in FIG. 9, the material, the plate thickness, and the machining method of the workpiece 16 are displayed under the heading of “1. Current Machining Information”. FIG. 9 also illustrates input fields to receive the number of times of initial search and the number of times of estimation search being displayed on the right of the heading “1. Current Machining Information”. Thus, the display unit 13 may be able to display a display area for receiving inputs with respect to the numbers of times of test machining. These input fields may each display a default value or a previous setting value, and allow the user to change the numbers in the input fields when the user wants to do so. The numerical value input to an input field is received by the input unit 14, and is then input from the input unit 14 to the applicable unit(s). The inputs regarding the number of times of initial search and the number of times of estimation search are input to the test machining condition generation unit 9 and to the candidate condition generation unit 10.

In the example illustrated in FIG. 9, the machining condition for the next test machining is displayed under the heading of “2. Next Search Condition”. The example illustrated in FIG. 9 also displays buttons for receiving an input as to whether to proceed to test machining, on the right of the heading “2. Next Search Condition”. Pressing the Yes button causes test machining to be performed, while pressing the No button causes, for example, another candidate for machining condition to be used in the test machining to be displayed. The machining condition to be used in the test machining may be configurable depending on a user request in this manner.

The example illustrated in FIG. 9 has an input field provided to display the evaluation result obtained by the test machining and to correct the evaluation result, under the heading of “3. Machining Result Input”. Pressing the Yes button in “2. Next Search Condition” section causes test machining to be initiated using the displayed machining condition, and the determination result from the machining determination unit 5 to then be displayed in the “Score of Machining” field. This example assumes that the determination result from the machining determination unit 5 is calculated as an evaluation value, and this evaluation value is displayed as the score. A user wanting to change this value changes the numerical value in the input field. The numerical value input in the input field is received by the input unit 14, and is then input from the input unit 14 to the machining determination unit 5. Upon correction of the score, which is an evaluation value, the machining determination unit 5 stores the evaluation value resulting from the correction in the first information storage unit 7, and outputs the evaluation value to the condition search unit 6. Note that in a case in which the machining determination unit 5 makes a determination with respect to a machining defect mode, the machining defect mode may be displayed.

In the example illustrated in FIG. 9, the candidate condition is displayed under the heading of “4. Candidate Condition”. The candidate condition is displayed when the test machining is complete. Buttons for receiving an input as to whether to proceed to check machining are displayed on the right of the heading “4. Candidate Condition”. Pressing the Yes button causes check machining to be performed, while pressing the No button may cause the test machining to continue or the machining condition search process to be stopped.

The screen illustrated in FIG. 10 is displayed after proceeding to check machining. In the example illustrated in FIG. 10, the material, the plate thickness, and the machining method of the workpiece 16 are displayed under the heading of “5. Check Machining”. The example illustrated in FIG. 10 displays buttons for setting as to whether to check three machining tolerances with respect to power tolerance checking, speed tolerance checking, and focus tolerance checking, under the heading of “6. Validity Status of Tolerance Check Items”. Power tolerance checking means checking of a machining tolerance with respect to the output power of the laser beam, which is one of the control parameters. Speed tolerance checking means checking of a machining tolerance with respect to the output power of the laser beam, which is one of the control parameters. Focus tolerance checking means checking of a machining tolerance with respect to the focus position, which is one of the control parameters. Pressing the Validate button causes checking of the machining tolerance of that control parameter to be performed in the check machining. When the Invalidate button of an item is pressed, checking of the machining tolerance of that control parameter to be performed in the check machining, is not performed. Thus, the display unit 13 may be able to display a display area for receiving an indication with respect to the control parameter whose machining tolerance is to be checked in the check machining.

In the example illustrated in FIG. 10, the candidate condition is displayed under the wording of “7. Do you want to perform check machining?”. The example illustrated in FIG. 10 also displays buttons for receiving an input as to whether to perform check machining, on the right of the heading “7. Do You Want to Perform Check Machining?”. In addition, on the right of the candidate condition, the position corresponding to the candidate condition is indicated by the solid black circle, the machining condition to be used in next check machining is indicated by the triangle, and the boundary between the good machining region estimated through the test machining and the poor machining region is indicated by the broken line, where the axes represent the respective control parameters whose machining tolerances are to be checked. Thus, the display unit 13 may be able to display the candidate condition, the machining condition to be used in the check machining, and the like at points in a control parameter space. Such display allows the user to more easily understand with what machining condition the check machining is to be performed.

The wording “8. Check Machining is Complete.” illustrated in FIG. 10 is displayed when the check machining is complete. The optimum machining condition is displayed under the heading “8. Check Machining is Complete.”. In the example illustrated in FIGS. 9 and 10, the control parameters include at least one of the machining speed, the focus position, and the assist gas pressure in the laser machining tool 101. The tolerance check unit 11 causes the check machining to be performed to check the machining tolerance for at least one of the machining speed, the focus position, and the assist gas pressure. Note that the display screens illustrated in FIGS. 9 and 10 are merely an example of display screen, and the displayed items, the arrangement, the method for receiving inputs, and the like are not limited to those in the example illustrated in FIGS. 9 and 10.

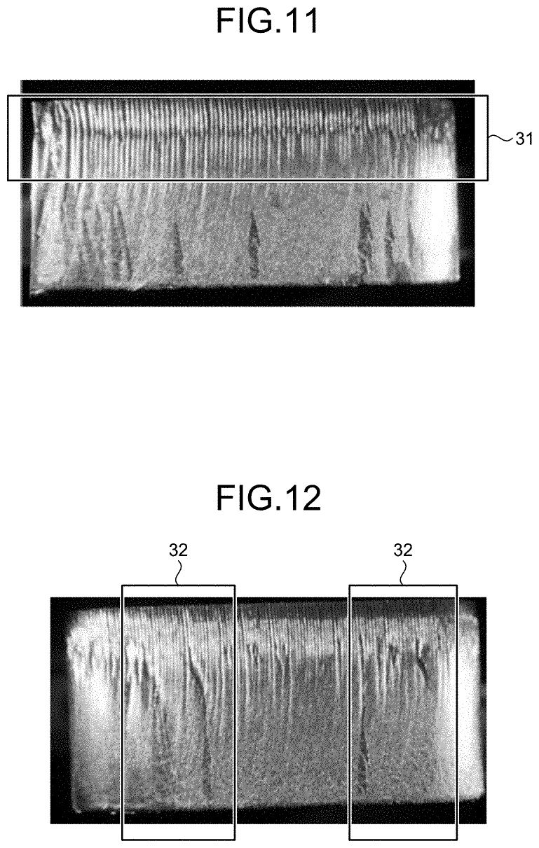

Specific examples of the above machining defect modes will next be described. Examples of the machining defect modes that likely to occur in the laser machining tool 101 include rough surface irregularities, flaws, oxide film peel-off, and dross. FIG. 11 is a view illustrating an example of cut surface of the workpiece 16 that has been cut by the laser machining tool 101 of the present embodiment in a case of occurrence of rough surface irregularities. The portion shown in a portion 31 of FIG. 11 is the characteristic portion of rough surface irregularities. As illustrated in FIG. 11, a series of periodic rough surface irregularities appears in an upper portion of the cut surface. Occurrence of rough surface irregularities increases the depth of asperities of the linear marks as compared to when no rough surface irregularities occur. A criterion to determine whether rough surface irregularities are occurring may be, for example, whether the surface roughness of the cut surface is greater than or equal to a certain value.

FIG. 12 is a view illustrating an example of cut surface of the workpiece 16 that has been cut by the laser machining tool 101 of the present embodiment in a case of occurrence of flaws. As shown in portions 32, flaws locally occur on the cut surface from the top surface to the bottom surface. Thus, whether flaws are present or not can be determined based on, for example, the difference in lightness of pixels of an image captured from the cut surface, or the like.

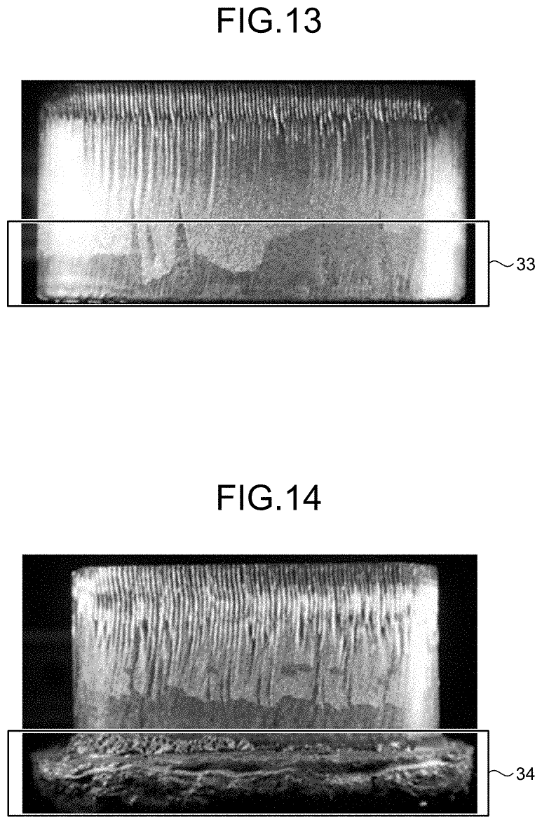

FIG. 13 is a view illustrating an example of cut surface of the workpiece 16 that has been cut by the laser machining tool 101 of the present embodiment in a case of occurrence of oxide film peel-off. The portion shown in a portion 33 is the characteristic portion of oxide film peel-off. Oxide film peel-off can occur when oxygen is used as the assist gas for cutting, and is a phenomenon that the oxide film generated on the cut surface peels off, occurring in a lower portion of the cut surface. Thus, whether oxide film peel-off is present or not can be determined based on, for example, the difference in lightness of pixels in a lower portion of the cut surface of an image captured from the cut surface, or the like.

FIG. 14 is a view illustrating an example of cut surface of the workpiece 16 that has been cut by the laser machining tool 101 of the present embodiment in a case of dross generation. The portion shown in a portion 34 is the characteristic portion of dross. Dross is a phenomenon that metal or the like melted during cutting adheres on the cut surface, occurring from the bottom end of the cut surface. Thus, regarding the presence or absence the oxide film peel-off, whether dross is present or not can be determined based on, for example, the difference in lightness of pixels in a bottom portion of the cut surface of an image captured from the cut surface, or the like. Note that the method for making a determination with respect to each of the machining defect modes is not limited to the foregoing examples.

In addition, the machining determination unit 5 may make a determination with respect to a machining defect mode other than the machining defect modes described above. Examples of machining defect mode other than the machining defect modes described above include occurrence of color change of the cut surface depending on the purity of the assist gas, presence or absence of a vibrating surface due to mechanical vibration of the machining tool itself, and gouging, which is blow-up of melted material to the machined surface due to non-penetration of the laser. A different type of machining defect may occur depending on the type of assist gas. For example, in a case of oxygen cutting in which the type of assist gas is oxygen, an oxide film is generated on the cut surface, and thus the machining defect modes include oxide film peel-off. In contrast, in a case of nitrogen cutting in which the type of assist gas is nitrogen, no oxide film is generated on the cut surface, which eliminates the need to include oxide film peel-off in the machining defect modes.

As described above, the laser machining system 100 of the present embodiment performs test machining, and using the machining result obtained through the test machining, estimates the good machining region, and determines the candidate condition which is a candidate for the optimum machining condition. The laser machining system 100 then performs check machining to check whether the machining tolerance of the candidate condition is greater than or equal to a reference value. If the machining tolerance is greater than or equal to the reference value, the laser machining system 100 determines that the candidate condition is the optimum machining condition. Thus, the laser machining system 100 of the present embodiment can check whether the machining condition has robustness.

### Second Embodiment

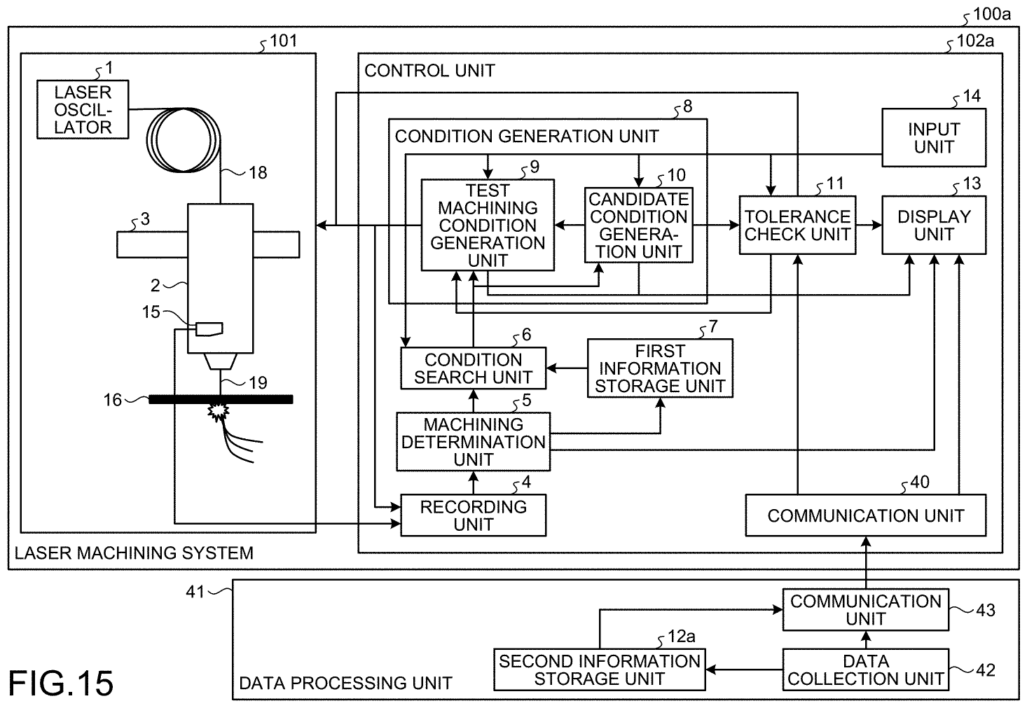

FIG. 15 is a diagram illustrating an example configuration of a laser machining system 100a according to a second embodiment of the present invention. As illustrated in FIG. 15, the laser machining system 100a includes the laser machining tool 101 similar to that of the embodiment, and a control unit 102a. The components having functionality similar to the functionality in the first embodiment are hereinafter designated by like reference characters as the first embodiment. Duplicate description thereof will be omitted, and portions different from the first embodiment will be primarily described.

The control unit 102a is similar to the control unit 102 of the first embodiment except in including a communication unit 40 in place of the second information storage unit 12. The communication unit 40 communicates with a data processing unit 41.

The data processing unit 41 is a device capable of transmitting information collected by a remote diagnosis service. The data processing unit 41 is implemented by, for example, a cloud server, and is a device that provides a remote diagnosis service that is a remote diagnosis capability regarding the laser machining system. Alternatively, the data processing unit 41 may be a device that collects information obtained by a remote diagnosis service, from another device that provides the remote diagnosis service. The data processing unit 41 includes a data collection unit 42 which collects information collected by the remote diagnosis service, a second information storage unit 12a, and a communication unit 43. The data collection unit 42 stores the collected information in the second information storage unit 12a. Information obtained by the remote diagnosis service that is a remote diagnosis function, that is, information collected by the remote diagnosis service, is information representing the state of another laser machining system upon occurrence of a machining defect, the another laser machining system being other than the laser machining system 100a of the present embodiment.

To diagnose the cause of a machining defect, the remote diagnosis service typically collects, on a real-time basis, the operational status of a laser machining system before and after occurrence of the machining defect, information about the configured machining condition, and the like. Examples of the information obtained by the remote diagnosis service include the operational status of a laser machining system, management information, consumption information, and the alarm occurrence status. An alarm indicates occurrence of a machining defect in a laser machining system. The operational status of a laser machining system refers to, for example, the operating time, information representing details of the machining program, the actual machining time, information on the material and on the plate thickness, the remaining machining time, operational performance, and roughly estimated cost. The management information refers to, for example, the powered-on time and the beam-irradiated time. The consumption information refers to, for example, the process lens operating time, the consumption time of optical glass for machining head protection, the total machining time, the nozzle operating time, the assist gas consumption, and the machining time of each machined material. The information obtained by the remote diagnosis service may also include alarm occurrence history. In addition, the second information storage unit 12a stores information similar to the information stored in the second information storage unit 12 of the first embodiment, i.e., information of designing of machining conditions, information about machining tolerance obtained in development work in the past, and the like. In the present embodiment, performing check machining using these types of information allows a machining condition for use in check machining to be efficiently and appropriately set.

An operation of the present embodiment will now be described. The operation of test machining is similar to the operation thereof in the first embodiment. When check machining is started, the tolerance check unit 11 generates a machining condition for use in the check machining based on information obtained from the second information storage unit 12a via the communication unit 40 and via the communication unit 43. Specifically, the tolerance check unit 11 generates a machining condition for the check machining to avoid a machining condition that has caused alarm, based on the information obtained from the second information storage unit 12a. For example, when an alarm for the laser oscillator 1 was generated immediately before now, that is, within a certain time before now, the laser output power or the frequency may be changed. Alternatively, when an alarm has occurred for a laser machining system having a similar operational status and/or consumption information, check machining may be performed to avoid the machining condition that had been set at the time of occurrence of this alarm. Such operation enables the laser machining system 100a of the present embodiment to complete the check machining more precisely in a shorter time. The operation of the present embodiment other than the operation described above is similar to the operation of the first embodiment. Note that similarly to the first embodiment, the second information storage unit 12 may be included in the control unit 102a to allow the tolerance check unit 11 to use both the information stored in the second information storage unit 12 and the information obtained from the second information storage unit 12a via the communication unit 40 and via the communication unit 43 to generate a machining condition for use in the check machining. The user may be allowed to select which one to use, either the information stored in the second information storage unit 12 or the information obtained from the second information storage unit 12a via the communication unit 40 and via the communication unit 43.

Moreover, the tolerance check unit 11 may learn a tolerance check item using unsupervised learning. Unsupervised learning is a learning method for learning the distribution of input data only with a large amount of input data given to the machine learning device, and performing compression, classification, shaping, and the like on the input data without labeled training output data corresponding thereto being given. Use of unsupervised learning with, as input data, a dataset including various items of data stored in the second information storage unit 12a enables, for example, the dataset to be grouped into clusters having similar features. Setting a certain criterion and assigning outputs that will optimize this using this result enables the outputs to be predicted. Examples of the outputs include a control parameter whose machining tolerance needs adjustment, and a machining tolerance to be achieved. For example, a machine learning model is installed in the tolerance check unit 11, and the information obtained from the remote diagnosis service (hereinafter referred to as obtained information) and a control parameter whose machining tolerance has been adjusted are input to the machine learning model. Then, the machine learning model performs clustering on the input data, which associates with each other the obtained information and the control parameter needing adjustment that have been grouped into a same cluster. Performing such learning enables the tolerance check unit 11 to select the control parameter needing adjustment depending on the content of information included in the obtained information. The tolerance check unit 11 generates a machining condition to preferentially adjust the control parameter needing adjustment. For example, when the values of the assist gas consumption amount and of the actual machining time at the time of checking of the machining tolerance are each beyond the reference value thereof, and these values belong to a certain cluster, control parameters classified into the same cluster, such as the machining speed and the assist gas, are selected as the control parameter to be adjusted. The tolerance check unit 11 may also display the control parameter needing adjustment on the display unit 13. Similarly to the case of a control parameter, the machining tolerance to be achieved can also be associated with the obtained information using a machine learning model. In addition, a technique called semi-supervised learning is also available for an intermediate level of problem setting between unsupervised learning and supervised learning. Semi-supervised learning corresponds to a situation in which a pair of input data and output data is given in partial, and input data only is given for the reminder. Clustering may also be performed using semi-supervised learning.

As described above, the laser machining system 100a of the present embodiment performs check machining based on information obtained by the remote diagnosis service. This provides an advantage similar to the advantage of the first embodiment, and also enables check machining to be performed suitably in a shorter time.

The configurations described in the foregoing embodiments are merely examples of various aspects of the present invention. These configurations may be combined with a known other technology, and moreover, a part of such configurations may be omitted and/or modified without departing from the spirit of the present invention.

### REFERENCE SIGNS LIST

1 laser oscillator; 2 machining head; 3 drive unit; 4 recording unit; 5 machining determination unit; 6 condition search unit; 7 first information storage unit; 8 condition generation unit; 9 test machining condition generation unit; 10 candidate condition generation unit; tolerance check unit; 12, 12a second information storage unit; 13 display unit; 14 input unit; 15 detection unit; 16 workpiece; 18 optical path; 100, 100a laser machining system; 101 laser machining tool; 102, 102a control unit.

1. A laser machining system comprising:
a laser machining tool; and
first processing circuitry
to detect a machining state of the laser machining tool;
to generate a machining condition including at least one control parameter settable to the laser machining tool;
to determine quality of machining based on the machining state detected;
to generate a candidate condition which is a candidate for a machining condition to be set to the laser machining tool, based on a determination result from the machining determination and on a machining condition corresponding to the determination result; and
to cause check machining to be performed for checking a machining tolerance using the candidate condition, the machining tolerance indicating robustness of the candidate condition.

2. The laser machining system according to claim 1, wherein
the first processing circuitry further estimates a determined-to-be-good region in a space of the at least one control parameter, based on the determination result and on the machining condition corresponding to the determination result, the determined-to-be-good region being a region in which quality of machining is expected to result in good quality, wherein
the first processing circuitry generates the candidate condition based on the determined-to-be-good region.

3. The laser machining system according to claim 2, wherein the first processing circuitry generates the machining condition by selecting one from machining conditions used in past machining.

4. The laser machining system according to claim 2, wherein the first processing circuitry generates multiple ones of the machining condition, determines the quality of machining for each of the multiple ones of the machining condition, and estimates the determined-to-be-good region based on the multiple ones of the machining condition.

5. The laser machining system according to claim 1, wherein the first processing circuitry generates multiple ones of the machining condition, determines the quality of machining for each of the multiple ones of the machining condition, and generates the candidate condition based on the determination results corresponding to the multiple ones of the machining condition.

6. The laser machining system according to claim 1, wherein
the first processing circuitry determines that the candidate condition is an optimum machining condition when the candidate condition has a machining tolerance that meets a predetermined criterion, and generates a machining condition when the candidate condition does not have a machining tolerance that meets the predetermined criterion, and
when the first processing circuitry generates a machining condition, a process of the machining condition generation, of the machining determination, of the candidate condition generation, and of the tolerance checking is performed again.

7. The laser machining system according to claim 1, wherein the first processing circuitry determines that the candidate condition is an optimum machining condition when the candidate condition has a machining tolerance that meets a predetermined criterion, and
modifies a value of at least part of at least one control parameter of the candidate condition, and causes the check machining to be performed again based on the candidate condition after modification when the candidate condition does not have a machining tolerance that meets the predetermined criterion.

8. The laser machining system according to claim 1,
the first processing circuitry receives, from a data collection device capable of transmitting information collected by a remote diagnosis service, the information collected, wherein
the information collected is information indicating a state of another laser machining system upon occurrence of a machining defect in the another laser machining system, and
the first processing circuitry generates a machining condition for use in the check machining using the information collected received.

9. The laser machining system according to claim 1, wherein
the candidate condition includes, as the at least one control parameter, at least one of a machining speed, a focus position, or an assist gas pressure of the laser machining tool, and
the first processing circuitry causes the check machining to be performed for checking the machining tolerance for at least one the machining speed, the focus position, or the assist gas pressure.

10. The laser machining system according to claim 1, wherein
the first processing circuitry makes a determination with respect to a machining defect mode, the machining defect mode indicating a type of machining defect, and
the first processing circuitry generates the machining condition to preferentially modify a control parameter corresponding to the machining defect mode.

11. The laser machining system according to claim 1, comprising:
a display capable of displaying a display area for receiving an input with respect to a number of times of test machining, the test machining being performed to determine the candidate condition.

12. The laser machining system according to claim 11, wherein the display is capable of displaying a display area for receiving an indication with respect to the at least one control parameter whose machining tolerance is to be checked in the check machining.

13. The laser machining system according to claim 11, wherein the display is capable of displaying the machining condition for use in the check machining as a point in a space of the at least one control parameter.

14. A machining condition search device comprising:
second processing circuitry
to generate a machining condition including at least one control parameter settable to a laser machining tool;
to determine quality of machining based on a result of detection of a machining state of the laser machining tool;
to generate a candidate condition being a candidate for a machining condition to be set to the laser machining tool, based on a determination result from the machining determination and on a machining condition corresponding to the determination result; and
to cause check machining to be performed for checking a machining tolerance using the candidate condition, the machining tolerance indicating robustness of the candidate condition.

15. A machining condition search method, comprising:
generating a machining condition including at least one control parameter settable to a laser machining tool;
determining quality of machining based on a result of detection of a machining state of the laser machining tool;
generating a candidate condition which is a candidate for a machining condition to be set to the laser machining tool, based on a determination result from the machining determination step and on a machining condition corresponding to the determination result; and
causing check machining to be performed for checking a machining tolerance using the candidate condition, the machining tolerance indicating robustness of the candidate condition.
